(19) United States
(12) Patent Application Publication
(10) Pub. No.: US 2008/0009585 A1
(43) Pub. Date: Jan. 10, 2008

(54) Water-soluble substrate with resistance to dissolution prior to being immersed in water

(75) Inventor: Vincenzo Catalfamo, Cincinnati, OH (US)

Correspondence Address: THE PROCTER & GAMBLE COMPANY;INTELLECTUAL PROPERTY DIVISION - WEST BLDG., WINTON HILL BUSINESS CENTER - BOX 412, 6250 CENTER HILL AVENUE, CINCINNATI, OH, 45224, US

(73) Assignee: The Procter & Gamble Company

(21) Appl. No.: 11/824,702

(22) Filed: Jul. 2, 2007

Related U.S. Application Data
(60) Provisional application No. 60/818,695, filed on Jul. 5, 2006.

(51) Int. Cl. C08G 63/50

(52) U.S. Cl. 525/57

(57) ABSTRACT

A water-soluble substrate, and more particularly a water-soluble substrate that is resistant to contact with small amounts of water, and methods of making the same are disclosed. At least one of the substrate's surfaces comprises first discrete zones having a water-solubility which is less than the water-solubility of said water-soluble substrate. The first discrete zones represent from 10% to 90% of the surface area of said first or second surface.

### CROSS REFERENCE TO RELATED APPLICATION

This application claims the benefit of U.S. Provisional Application Ser. No. 60/818,695, filed Jul. 5, 2006, the disclosure of which is incorporated by reference.

### FIELD OF THE INVENTION

This invention relates to a water-soluble substrate, and more particularly a water-soluble substrate which has improved resistance to dissolution prior to being immersed in water, and methods of making the same. This invention also relates to articles, such as pouches, made from the water-soluble substrate.

### BACKGROUND OF THE INVENTION

Water-soluble substrates are gaining wider acceptance for use as packaging materials. Packaging materials include films, sheets, blown or molded hollow bodies (i.e. sachets, pouches, and tablets), bottles, receptacles and the like. Often, water-soluble substrates, when used in the preparation of certain types of these articles such as sachets and pouches, disintegrate and/or become sticky when exposed to small amounts of water or high humidity. This can make them unsuitable for usage in the packaging and storage of the compositions contained therein.

The most common consumer complaint for water-soluble pouches is linked to unwanted pouch dissolution when accidentally exposed to small amounts of water, such as when water gets inside the outer packaging in which the pouches are sold and stored after purchase, from wet hands, high humidity, leaking sinks, or pipes during storage. This may cause the water-soluble pouches to leak prior to use and/or stick together. The second most frequent complaint is that of the water-soluble pouch failing to fully dissolve upon use. Thus, there remains an unmet need for water-soluble substrates and articles made therefrom, such as sachets and pouches, which have improved resistance to dissolution against exposure to small amounts of water yet can subsequently dissolve very quickly when immersed in an aqueous solution, such as rinse and/or wash water.

Various methods are known in the art to retard the dissolution of water-soluble substrates. These methods comprise coating the entire surface of the water-soluble substrate with a water-insoluble material. For example, U.S. Pat. No. 6,509,072 describes a water-soluble substrate comprising a barrier coating. The barrier coating is a polymeric film which forms a continuous film on the water-soluble substrate. Another example of a barrier coating is described in WO 01/23460, assigned to Kao Corporation, wherein a surface of the water-soluble substrate is coated with a particulate or fibrous water-insoluble material.

It has now been surprisingly found that the entire surface of the water-soluble substrate need not be coated in order to provide the water-soluble substrate with improved resistance against dissolution. As such, less coating material is required, which allows to manufacture water-soluble substrates with improved resistance against dissolution at lower cost. It has also been surprisingly found that the resistance against dissolution can be further improved by creating solubility gradients.

It is therefore an aspect of the present invention to provide water-soluble substrates which have improved resistance to dissolution prior to being immersed in water, yet can subsequently dissolve very quickly when immersed in an aqueous solution, such as rinse and/or wash water.

### SUMMARY OF THE INVENTION

The present invention relates to a water-soluble substrate comprising a first surface and a second surface opposite to said first surface, characterized in that at least one of said first or second surfaces comprises first discrete zones having a water-solubility which is less than the water-solubility of said water-soluble substrate, said first discrete zones representing from 10% to 90% of the surface area of said first or second surface.

The present invention also relates to an articles comprising the water-soluble substrate, and to a method of making the water-soluble substrate.

### BRIEF DESCRIPTION OF THE DRAWINGS

FIG. 1 shows a cross-section of a non-coated water-soluble substrate.

FIG. 2 shows a top view of one embodiment of a water-soluble substrate according to the present invention.

FIG. 3 shows a top view of another embodiment of a water-soluble substrate according to the present invention.

FIG. 4 shows a cross-section of an article comprising a water-soluble substrate according to the present invention.

### DETAILED DESCRIPTION OF THE INVENTION

This invention relates to a water-soluble substrate, and more particularly a water-soluble substrate which has improved resistance to dissolution prior to being immersed in water, and methods of making the same. This invention also relates to articles, such as water-soluble pouches, made from the water-soluble substrate described herein.

### Water-Soluble Substrate

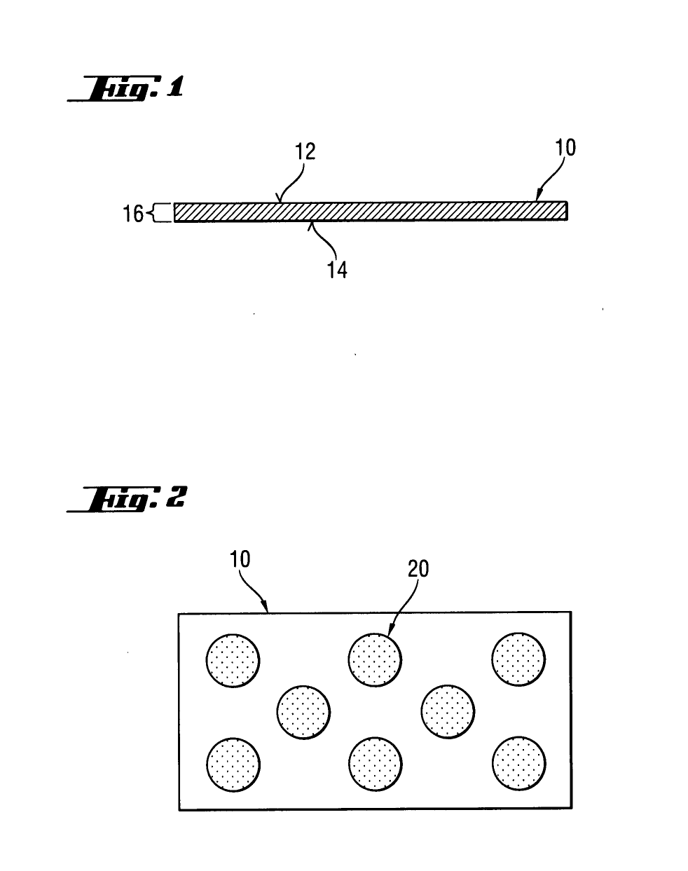

FIG. 1 shows a cross-section of a water-soluble substrate 10. The water-soluble substrate 10 has a first surface 12, a second surface 14 opposite to the first surface 12, and a thickness 16 between the first surface 12 and the second surface 14. The water-soluble substrate 10 can be in the form of a film, a sheet, or a foam, and includes woven and nonwoven structures.

The water-soluble substrate is made of polymeric materials and has a water-solubility of at least 50 weight %, as measured by the method set out here after using a glass-filter with a maximum pore size of 20 microns. Preferably, the water-solubility of the substrate is at least 75 weight % or even more preferably at least 95 weight %.

50 grams □ 0.1 gram of substrate material is added in a pre-weighed 400 ml beaker and 245 ml □ 1 ml of 25° C. distilled water is added. This is stirred vigorously on a magnetic stirrer set at 600 rpm, for 30 minutes. Then, the mixture is filtered through a folded qualitative sintered-glass filter with a pore size as defined above (max. 20 micron). The water is dried off from the collected filtrate by any conventional method, and the weight of the remaining material is determined (which is the dissolved fraction). Then, the % solubility can be calculated.

Typically the water-soluble substrate 10 has a basis weight of from 0.33 to 1,667 grams per square meter, preferably from 33 to 167 grams per square meter. The thickness of the water-soluble substrate 10 between the first surface 12 and the second surface 14 can range from about 0.75 micrometer to about 1,250 micrometer, preferably from about 10 micrometer to about 250 micrometer, more preferably from about 25 micrometer to about 125 micrometer.

Preferred polymers, copolymers or derivatives thereof suitable for use as substrate material are selected from polyvinyl alcohol (PVA), polyvinyl pyrrolidone, polyalkylene oxides, acrylamide, acrylic acid, cellulose, cellulose ethers, cellulose esters, cellulose amides, polyvinyl acetates, polycarboxylic acids and salts, polyaminoacids or peptides, polyamides, polyacrylamide, copolymers of maleic/acrylic acids, polysaccharides including starch and gelatine, natural gums such as xanthum and carragum, polyacrylates and water-soluble acrylate copolymers, methylcellulose, carboxymethylcellulose sodium, dextrin, ethylcellulose, hydroxyethyl cellulose, hydroxypropyl methylcellulose, maltodextrin, polymethacrylates, polyvinyl alcohol copolymers, hydroxypropyl methyl cellulose (HPMC), and mixtures thereof. The most preferred polymer is polyvinyl alcohol. Preferably, the level of polymer in the substrate is at least 60%.

An example of commercially available water-soluble films are PVA films known under the trade reference MonoSol M8630, as sold by MonoSol LLC of Gary, Ind., US, and PVA films of corresponding solubility and deformability characteristics. Other films suitable for use herein include films known under the trade reference PT film or the K-series of films supplied by Aicello, or VF-HP film supplied by Kuraray.

### Discrete Zones

As shown in FIG. 2, at least one of the first or second surfaces 12, 14 of the water-soluble substrate 10 comprises first discrete zones 20 having a water-solubility which is less than the water-solubility of the water-soluble substrate. With “discrete zones” it is meant zones having a relatively small exposed surface area, preferably from 0.1 mm² to 400 mm², more preferably from 1 mm² to 200 mm², even more preferably from 10 mm² to 100 mm², and which do not contact each other. As such, the first discrete zones 20 represent a pattern which can be random or non-random. These first discrete zones 20 combined, represent from 10%, preferably from 20%, more preferably from 30%, even more preferably from 40% and up to 70%, preferably up to 80% and more preferably up to 90% of the surface area of the first or second surface 12, 14. The first discrete zones 20 increase the overall resistance to solubility of the entire water-soluble substrate. Without being bound by theory, it is believed that the resistance to solubility does not depend solely on the thickness or on the solubility (or resistance thereto) of the water-soluble substrate 10, nor solely on the thickness, solubility (or resistance thereto) or coverage of the first discrete zones 20. Instead, the overall resistance of the combined substrate, that is the water-soluble substrate 10 in combination with the first discrete zones 20, and the time for the water to reach the water soluble substrate 10 through the available vertical as well as horizontal pathways created by the discrete zones, is what matters.

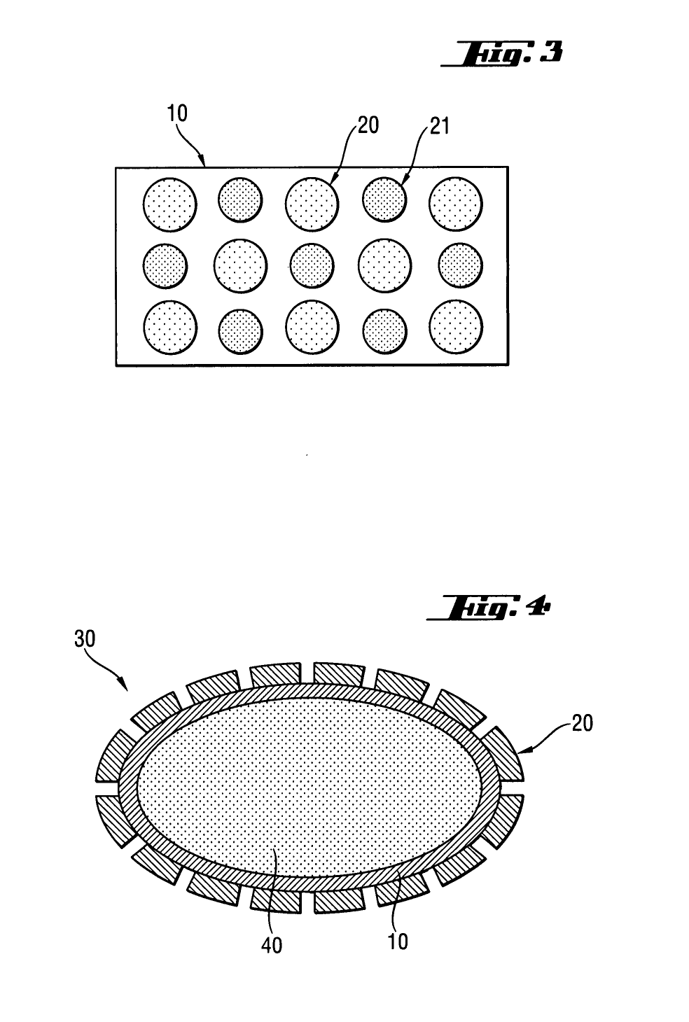

In a preferred embodiment and as shown in FIG. 3, the water-soluble substrate 10 comprises second discrete zones 21 having a water-solubility which is less than the water-solubility of the water-soluble substrate 10, and which is different than the water-solubility of the first discrete zones 20. As such, solubility gradients are created both in a horizontal as well as vertical direction, thereby further enhancing the resistance to dissolution. The second discrete zones 21 can be on the same surface as the first discrete zones 20, on the opposite surface, or on both surfaces. When the second discrete zones 21 are on the same surface of the water-soluble substrate than the first discrete zones 20, then the second discrete zones 21 are present in those areas not yet covered by the first discrete zones 20. When the second discrete zones 21 are on the surface opposite to the surface comprising the first discrete zones 20, then the second discrete zones 21 are at least present in those areas of which the opposite area is not covered by the first discrete zones 20. The second discrete zones 21 combined, preferably represent from 10%, preferably from 20%, more preferably from 30%, even more preferably from 40% and up to 70%, preferably up to 80% and more preferably up to 90% of the surface area of the first or second surface 12, 14.

The first and second discrete zones 20, 21 can be created in various ways. In a first embodiment, the discrete zones 20, 21 can be created by applying a coating material. Examples of coating materials include, but are not limited thereto:
a composition comprising polyvinyl alcohol having a high hydrolysis degree. The hydrolysis degree of the polyvinyl alcohol is preferably greater than 97%. The composition can be comprised substantially entirely of polyvinyl alcohol, or it can be a mixture of polyvinyl alcohol with other suitable water-soluble or water dispersible materials, as described above.
a water-insoluble material. The water-insoluble material may be a water-insoluble inorganic material or a water-insoluble organic material. With “water-insoluble material”, it is meant that the solubility is less than 50 weight %, as measured according to the previously described method. Preferably, the water-solubility is less than 40 weight %, more preferably less than 30 weight %, and most preferably less than 10 weight %.

The water-insoluble inorganic material may be zeolite, bentonite, talc, mica, kaolin, sepiolite, silica, calcium carbonate, titanium oxide, anhydrous silicic acid, hydroxy calcium apatite, phthalocyanine blue, Helindone Pink, Hansa Orange, pearlescent material, etc., while zeolite, bentonite, talk, mica, kaolin, silica, titanium oxide, silicone, etc. are preferred.

The water-insoluble organic material may be a synthetic polymer such as polyethylene, polypropylene, polyamide, polyethylene terephthalate, polystyrene, polyurethane and/or its cross-linked product, sodium poly(meth)acrylic acid, poly(meth)acrylic acid ester and/or its cross-linked product, rubber such as ethylene rubber, propylene rubber, styrene-butadiene rubber, butadiene rubber, silicone rubber, etc. and/or its cross-linked products, etc.; or a natural polymer such as cellulose and/or its derivatives, seed hulls, starch and/or their derivatives, while polyethylene, polyamide, polystyrene, sodium poly(meth)acrylic acid, poly(meth)acrylic acid ester, cellulose and/or its derivatives, starch and/or their derivatives, are preferred. Here, poly(meth)acrylic acid means both polyacrylic acid and polymethacrylic acid.

The coating material may be in the form of particles. Preferred particles are polymeric particles including particles made of synthetic materials as described above. Also preferably, these particles have an average diameter of 500 micrometers or less, more preferably 300 micrometers or less, even more preferably from 0.01 to 300 micrometers. In a highly preferred embodiment, the particles are in the nanosize-range, with average particle diameters of from 0.01 to 1 micrometer. Coating the water-soluble substrate 10 with nano-sized particles further provides the benefit that the coating becomes transparent, which is aesthetically preferred. Suitable nanoparticles are polyethylene-, polypropylene-, wax-, silicone- or polytetrafluoroethylene-based nanoparticles.

The coating material may be present on the surface of the water-soluble substrate 10, or it may be partially embedded into said substrate as will be explained later.

In a second embodiment, the discrete zones 20, 21 may be created via energetic radiation treatment. By applying energetic radiation to the surface of the water-soluble substrate, portions of the substrate material are cross-linked and as such, the properties of the substrate is locally modified so as to provide zones which have a different solubility than the rest of the water-soluble substrate. Suitable energetic radiation treatments include ultraviolet, X-ray, gamma ray, beta ray and high electron beam treatment.

In yet another embodiment, the discrete zones 20, 21 may be created via a combination of a coating material and applying energy.

The first (and where applicable, second) discrete zones create patterns which can be random or non-random. When the discrete zones are created with coating materials, they may be transparent or translucent. Alternatively, they may be colored or three-dimensional in order to create appealing effects such as tactile (touch) effects or visual effects, such as graphics, cartoons, logo's, branding, user's instructions, and the like.

When the water-soluble substrate according to the present invention is however immersed in water (i.e. in applications for which the substrate is designed to be used and required to dissolve), the coating is not sufficient to resist the water contact and ensures that the substrate dissolves rapidly.

### Optional Ingredients

It may be required for certain applications that the dissolution rate (when immersed) of the substrate is increased. Disintegrants may be added to the coating material (in those embodiments where the discrete zones are formed with a coating material) in order to speed up the dissolution when the water-soluble substrate is immersed in water. Preferably, the level of disintegrant in the coating is from 0.1 to 30%, preferably from 1 to 15%, by weight of said coating. Alternatively, disintegrants may also be applied on the surface of the water-soluble substrate 10 not covered by the discrete zones, or they may be integrated into the water-soluble film 10, or any combination thereof. Suitable disintegrants for use herein are corn/potato starch, methyl cellulose/celluloses, mineral clay powders, croscarmelose (cross-linked cellulose), crospovidine (cross-linked polymer), sodium starch glycolate (cross-linked starch).

The water-soluble substrate-forming composition and the water-soluble substrate 10 formed therefrom can also comprise one or more additive or adjunct ingredients. For example, the water-soluble substrate-forming composition and the water-soluble substrate 10 may contain: plasticizers, lubricants, release agents, fillers, extenders, anti-blocking agents, de-tackifying agents, antifoams, or other functional ingredients. The latter may, in the case of articles containing compositions for washing, include, but are not limited to functional detergent additives to be delivered to the wash water, for example organic polymeric dispersants, or other detergent additives.

Suitable plasticizers include, but are not limited to: glycerol, glycerin, diglycerin, hydroxypropyl glycerine, sorbitol, ethylene glycol, diethylene glycol, triethylene glycol, tetraethylene glycol, propylene glycol, polyethylene glycols, neopentyl glycol, trimethylolpropane, polyether polyols, ethanolamines, and mixtures thereof. The plasticizer can be incorporated in the water-soluble substrate 10 in any suitable amount including amounts in the range of from about 5% to about 30% by weight, or in the range of from about 12% to about 20% by weight.

Suitable surfactants may include the nonionic, cationic, anionic and zwitterionic classes. Suitable surfactants include, but are not limited to, polyoxyethylenated polyoxypropylene glycols, alcohol ethoxylates, alkylphenol ethoxylates, tertiary acetylenic glycols and alkanolamides (nonionics), polyoxyethylenated amines, quaternary ammonium salts and quaternized polyoxyethylenated amines (cationics), and amine oxides, N-alkylbetaines and sulfobetaines (zwitterionics). The surfactant can be incorporated in the water-soluble substrate 10 in any suitable amount including amounts in the range of from about 0.01% to about 1% by weight, or in the range of from about 0.1% to about 0.6% by weight.

Suitable lubricants/release agents include, but are not limited to, fatty acids and their salts, fatty alcohols, fatty esters, fatty amines, fatty amine acetates and fatty amides. The lubricant/release agent can be incorporated in the water-soluble substrate 10 in any suitable amount including amounts within the range of from about 0.02% to about 1.5% by weight, or in the range of from about 0.04% to about 0.15% by weight.

Suitable fillers, extenders, antiblocking agents, detackifying agents include, but are not limited to: starches, modified starches, crosslinked polyvinylpyrrolidone, crosslinked cellulose, microcrystalline cellulose, silica, metallic oxides, calcium carbonate, talc and mica. The filler, extender, antiblocking agent, detackifying agent can be present in the water-soluble substrate 10 in any suitable amount including amounts in the range of from about 0.1% to about 25% by weight, or in the range of from about 1% to about 15% by weight. In the absence of starch, it may be desirable for the filler, extender, antiblocking agent, detackifying agent to be present in a range of from about 1% to about 5% by weight.

Suitable antifoams include, but are not limited to, those based on polydimethylsiloxanes and hydrocarbon blends. The antifoam can be present in the water-soluble substrate 10 in any suitable amount including amounts in the range of from about 0.001% to about 0.5%, or in the range of from about 0.01% to about 0.1% by weight.

The water-soluble substrate-forming composition is prepared by mixing the materials and agitating the mixture while raising the temperature from about 70° F. (about 21° C.) to 195° F. (about 90° C.) until solution is complete. The substrate-forming composition may be made into any suitable form (e.g. film or sheets) and may then be subsequently formed into any suitable product (e.g. single- and multiple-compartment pouches, sachets, bags, etc.).

### Methods of Making a Water-Soluble Substrate

There are numerous non-limiting embodiments of the method of making the water-soluble substrate 10 described herein.

In one embodiment, the method comprises providing a previously formed water-soluble substrate 10 and creating first discrete zones 20 on one or both of the substrate's surfaces 12, 14. Optionally, second discrete zones 21 may be created consequently.

Where the discrete zones are formed using a coating material, this material can be applied to the previously formed water-soluble substrate 10 in a number of different manners. In one non-limiting embodiment, the coating material is applied to at least one of the surfaces 12, 14 of the previously formed water-soluble substrate 10 in the form of particles or a powder. Preferably, the particles or the powder are applied to the water-soluble substrate 10 via a jet, or electro-statically. Due to the high speed of the jet, some of the particles/powder is embedded into the substrate, thereby reducing, or even eliminating the need for using a binder. Also when the particles or powder are applied electro-statically, a binder is generally not needed. Nevertheless, a binder may be used. The binder may first be applied to the water-soluble substrate 10, before the particles or powder is applied. Or, alternatively, the binder may be mixed with the particles or powder, and then the mixture is added to the water-soluble substrate 10.

In another non-limiting embodiment of the method, the coating material is provided in the form of a solution that is applied onto at least one of the surfaces 12, 14 of the water-soluble substrate 10, and is allowed to dry, or undergoes a drying process. The solution can be applied on the film by means of any coating process, including spray, knife, rod, kiss, slot, painting, printing and mixtures thereof. Printing is preferred for use herein. Printing is a well established and economic process. Printing is usually done with inks and dyes and used to impart patterns and colours to substrates but in the case of the invention printing is used to deposit the less water-soluble material(s) onto a water-soluble substrate. Any kind of printing method can be used, including rotogravure, lithography, flexography, porous and screen printing, inkjet printing, letterpress, tampography and combinations thereof.

These embodiments may also comprise a step of wetting at least a portion of at least one of the surfaces 12, 14 of the water-soluble substrate 10 prior to applying the coating material to the previously formed water-soluble substrate 10. The wetting of at least one of the surfaces 12, 14 of the water-soluble substrate 10 may be used to at least partially dissolve or solubilize an outer portion of the surface 12, 14 of the substrate 10 (that is, part of the way into the thickness of the substrate). The water-soluble substrate 10 may be at least partially solubilized to any suitable depth in order to partially embed the coating into the substrate. Suitable depths include, but are not limited to: from about 1% to about 40% or about 45%, from about 1% to about 30%, from about 1% to about 20%, from about 1% to about 15%, and alternatively, from about 1% to about 10% of the overall substrate thickness 16. The coating material is then applied to the partially dissolved portion of at least one of the surfaces 12, 14 of the substrate 10. This allows the coating material to be embedded into an outer portion of the surface 12, 14 of the substrate 10, and to become a more permanent part of the substrate 10. The wetted surface 12, 14 of the substrate 10 with the coating material embedded into the same is then permitted to dry. Such an embodiment of the method may also comprise a step of removing at least some of any loose or excess of coating material remaining on the surface of the water-soluble substrate 10 after it has dried, such as by wiping or dusting the surface of the substrate 10.

In another embodiment, the coating material 20 can be added to the water-soluble substrate 10 after the substrate 10 is made into a product. For example, if the water-soluble substrate 10 is used to form a water-soluble pouch that contains a composition, the coating material can be added to the substrate 10 on at least a portion of the surface of the water-soluble pouch.

Where the first (and/or second) discrete zones are created via energetic radiation treatment, the radiation (as previously described) can be effected on previously formed substrates or on substrates which have already been made into a product.

### Methods of Making a Water-Soluble Pouch

The water-soluble substrate 10 described herein can be formed into articles, including but not limited to those in which the water-soluble substrate 10 is used as a packaging material. Such articles include, but are not limited to water-soluble pouches, sachets, and other containers.

Water-soluble pouches and other such containers that incorporate the water-soluble substrate 10 described herein can be made in any suitable manner known in the art. The water-soluble substrate 10 can be provided with improved resistance to dissolution either before or after forming the same into the final product. In either case, in certain embodiments it is desirable when making such articles, that the surface 12, 14 of the substrate 10 onto which the discrete zones are created, forms an outer surface of the product.

There are a number of processes for making water-soluble pouches. These include, but are not limited to processes known in the art as: vertical form-fill-sealing processes, horizontal form-fill sealing processes, and formation of the pouches in molds on the surface of a circular drum. In vertical form-fill-sealing processes, a vertical tube is formed by folding a substrate. The bottom end of the tube is sealed to form an open pouch. This pouch is partially filled allowing a head space. The top part of the open pouch is then subsequently sealed together to close the pouch, and to form the next open pouch. The first pouch is subsequently cut and the process is repeated. The pouches formed in such a way usually have pillow shape. Horizontal form-fill sealing processes use a die having a series of molds therein. In horizontal form-fill sealing processes, a substrate is placed in the die and open pouches are formed in these molds, which can then be filled, covered with another layer of substrate, and sealed. In the third process (formation of pouches in molds on the surface of a circular drum), a substrate is circulated over the drum and pockets are formed, which pass under a filling machine to fill the open pockets. The filling and sealing takes place at the highest point (top) of the circle described by the drum, e.g. typically, filling is done just before the rotating drum starts the downwards circular motion, and sealing just after the drum starts its downwards motion.

In any of the processes that involve a step of forming of open pouches, the substrate can initially be molded or formed into the shape of an open pouch using thermoforming, vacuum-forming, or both. Thermoforming involves heating the molds and/or the substrate by applying heat in any known way such as contacting the molds with a heating element, or by blowing hot air or using heating lamps to heat the molds and/or the substrate. In the case of vacuum-forming, vacuum assistance is employed to help drive the substrate into the mold. In other embodiments, the two techniques can be combined to form pouches, for example, the substrate can be formed into open pouches by vacuum-forming, and heat can be provided to facilitate the process. The open pouches are then filled with the composition to be contained therein.

The filled, open pouches are then closed, which can be done by any method. In some cases, such as in horizontal pouch-forming processes, the closing is done by continuously feeding a second material or substrate, such as a water-soluble substrate, over and onto the web of open pouches and then sealing the first substrate and second substrate together. The second material or substrate can comprise the water-soluble substrate 10 described herein. It may be desirable for the surface of the second substrate on which the less water-soluble material is distributed, to be oriented so that it forms an outer surface of the pouch.

In such a process, the first and second substrates are typically sealed in the area between the molds, and, thus, between the pouches that are being formed in adjacent molds. The sealing can be done by any method. Methods of sealing include heat sealing, solvent welding, and solvent or wet sealing. The sealed webs of pouches can then be cut by a cutting device, which cuts the pouches in the web from one another, into separate pouches. Processes of forming water-soluble pouches are further described in U.S. patent application Ser. No. 09/994,533, Publication No. US 2002/0169092 A1, published in the name of Catlin, et al.

### Articles of Manufacture

As shown in FIG. 4, the present invention may also include articles comprising a product composition 40 and a water-soluble substrate 10, which may be formed into a container 30, such as a pouch, a sachet, a capsule, a bag, etc. to hold the product composition. The surface of the water-soluble substrate 10 with the first discrete zones, may be used to form an outside surface of the container 30. The water-soluble substrate 10 may form at least a portion of a container 30 that provides a unit dose of the product composition 40.

For simplicity, the articles of interest herein will be described in terms of water-soluble pouches, although it should be understood that discussion herein also applies to other types of containers.

The pouches 30 formed by the foregoing methods, can be of any form and shape which is suitable to hold the composition 40 contained therein, until it is desired to release the composition 40 from the water-soluble pouch 30, such as by immersion of the water-soluble pouch 30 in water. The pouches 30 can comprise one compartment, or two or more compartments (that is, the pouches can be multi-compartment pouches). In one embodiment, the water-soluble pouch 30 may have two or more compartments that are in a generally superposed relationship and the pouch 30 comprises upper and lower generally opposing outer walls, skirt-like side walls, forming the sides of the pouch 30, and one or more internal partitioning walls, separating different compartments from one another. If the composition 40 contained in the pouches 30 comprises different forms or components, the different components of the composition 40 may be contained in different compartments of the water-soluble pouch 30 and may be separated from one another by a barrier of water-soluble material.

The pouches or other containers 30 may contain a unit dose of one or more composition 40 for use as/in laundry detergent compositions, automatic dishwashing detergent compositions, hard surface cleaners, stain removers, fabric enhancers and/or fabric softeners, food and beverage and new product forms where contact with small amounts of water could create premature pouch dissolution, unwanted pouch leakage and/or undesirable pouch-to-pouch stickiness. The compositions 40 in the pouches 30 can be in any suitable form including, but not limited to: liquids, liquigels, gels, pastes, creams, solids, granules, powders, etc. The different compartments of multi-compartment pouches 30 may be used to separate incompatible ingredients. For example, it may be desirable to separate bleaches and enzymes into separate compartments. Other forms of multi-compartment embodiments may include a powder-containing compartment in combination with a liquid-containing compartment. Additional examples of multiple compartment water-soluble pouches are disclosed in U.S. Pat. No. 6,670,314 B2, Smith, et al.

The water-soluble pouches 30 may be dropped into any suitable aqueous solution (such as hot or cold water), whereupon water-soluble substrate material 10 forming the water-soluble pouches 30 dissolves to release the contents of the pouches. The substrate and the pouches described herein may be soluble or dispersible in water, and have a water-solubility of at least about 50%, alternatively at least about 75%, or even at least about 95%, by weight. The solubility of the substrate and the pouches may be measured by a method of adding either a piece of substrate, or one of the pouches (including the substrate comprising the same) to distilled water, stirring the distilled water containing either the substrate or pouch vigorously using a magnetic stirrer, and filtering the water containing the substrate or pouch using a glass-filter with a maximum pore size of 20 microns. The dry weight of material collected on the filter is then compared to the weight of the initial sample, and is expressed as a percentage.

The water-soluble substrate 10 described herein can also be used for coating products and other articles. Non-limiting examples of such a product are laundry detergent tablets or automatic dishwashing detergent tablets.

### EXAMPLES

A first substrate is prepared by printing an Intelimer® Poly Tap 8000 (Landec Corporation) coating in discrete zones on one surface of a standard 3 mil soluble M8630 film supplied by Monosol. The Intelimer® coating is based on a polymer whose solubility is temperature activated (at 33° C.) and is mixed with water (20% Intellimer®, 80% water). The final film resulted partially coated (approx. 20% of area) with polymer particles insoluble at 23° C. water testing conditions.

A second substrate is prepared by printing an Intelimer® Poly Tap 8000 (Landec Corporation) coating in discrete zones on one surface of a standard 3 mil soluble M8630 film supplied by Monosol. This time, the Intelimer® coating is mixed with water to create a 50% Intellimer®/50% water coating. The final film resulted partially coated (approx. 50% of area) with polymer particles insoluble at 23° C. water testing conditions.

### Test Methods

### Droplet Test Method

To determine if a substrate is resistant to accidental water contact a Droplet Test method has been developed. In this test, a pouch (approx. 2″×2″) is formed from the above film in a cavity and a droplet of 0.2 ml of room temperature water is added to the formed side of the pouch. The formed side is the stressed case for this test since the film is thinned during cavity formation. A stopwatch is started as soon as the water contacts the pouch and the time when significant film deformation in the body of the pouch is observed, is recorded. This time, termed “Time to Deform” is a precursor to film failure.

### Full Solubility (Full Bath).

### The above formed film is immersed in a agitated 23° C. water bath and the time to completely (visually) dissolve the film is recorded.

### Results

| Material | Time to Deform | Film Solubility (full bath) |
|---|---|---|
| Uncoated M8630 film by | 15 seconds | 49 seconds |
| Monosol, 3 mil thickness | | |
| M8630 coated with 20% | 29 seconds | 127 seconds |
| Intelimer ® coating | | |
| M8630 coated with 50% | 29 seconds | 180 seconds |
| Intelimer ® coating | | |

### At coated film exposure temperatures above the Intelimer® solubility activation temperature of 33° C., the overall coated film solubility drops as expected due to the quicker solubilization of the Intellimer polymer material.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”
All documents cited in the Detailed Description of the Invention are, in relevant part, incorporated herein by reference; the citation of any document is not to be construed as an admission that it is prior art with respect to the present invention. To the extent that any meaning or definition of a term in this document conflicts with any meaning or definition of the same term in a document incorporated by reference, the meaning or definition assigned to that term in this document shall govern.
While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A water-soluble substrate comprising a first surface and a second surface opposite to said first surface, wherein at least one of said first or second surfaces comprises first discrete zones having a water-solubility which is less than the water-solubility of said water-soluble substrate, said first discrete zones combined comprise from about 10% to about 90% of the surface area of said first or second surface.

2. A water-soluble substrate according to claim 1, wherein said water-soluble substrate further comprises second discrete zones having a water-solubility which is less than the water-solubility of said water-soluble substrate, and which is different than the water-solubility of said first discrete zones.

3. A water-soluble substrate according to claim 2, wherein said first discrete zones and second discrete zones are on the first surface.

4. A water-soluble substrate according to claim 2, wherein said first discrete zones are on the first surface and said second discrete zones are on the second surface.

5. A water-soluble substrate according to claim 2, wherein said second discrete zones combined comprise from about 10% to about 90% of the surface area of said first or second surface.

6. An article comprising the water-soluble substrate according to claim 1, wherein said water-soluble substrate forms an outside surface of said article.

7. An article according to claim 10 wherein said article forms at least a portion of a container which holds a product composition.

8. A method of producing a water-soluble substrate comprising a first surface and a second surface opposite to said first surface comprising the step of forming first discrete zones on the first surface such that the first discrete zones combined comprise from about 10% to about 90% of the surface area of said first surface.

9. A method according to claim 8, further comprising the step of forming second discrete zones on the first or second surface of said water-soluble substrate such that the second discrete zones combined comprise from about 10% to about 90% of the surface area of said first or second surface.

10. A method according to claim 9, wherein the forming step for forming said second discrete zones is on the second surface.
